(19) United States
(12) Patent Application Publication
(10) Pub. No.: US 2002/0087443 A1
(43) Pub. Date: Jul. 4, 2002

(54) Financial management method and system

(76) Inventors: Nancy Williams, Ridgefield, CT (US); Daniel Krevis, Baskins Ridge, NJ (US); Laurie Winters, Scotts Plains, NJ (US)

Correspondence Address: Bickel & Brewer, 4800 Bank One Center, 1717 Main Street, Dallas, TX, 75201, US

(21) Appl. No.: 09/751,714

(22) Filed: Dec. 29, 2000

(51) Int. Cl. G06F 17/60; G06F 12/00; G06F 17/30

(52) U.S. Cl. 705/35; 707/200

(57) ABSTRACT

A method and system in a remote computer network (80) for interactively managing financial information, wherein the remote computer network (80) has at least one client (92) connectable to one or more servers (88). Initially, a deal center database can be designated wherein deal information is stored (384). An investment management database may be then specified wherein investment management information is stored (386). A financial management database is thereafter established, wherein financial management information is stored (388). Each of the databases are then integrated with one another in the remote computer network (80) to thereby permit users to access information stored in the databases utilizing the remote computer network (80). A deal center interface can then be specified for interactively accessing deal center information stored in the deal center database (390), in addition to an investment management interface for interactively accessing investment management information stored in the investment management information database (392). Finally, a financial management interface is established for interactively accessing financial management information stored in the financial management information database. Each of the interfaces are integrated with one another (394, 396, 398, 400) in the remote computer network to thereby permit users to access information stored in the databases through the interfaces.

### FIELD OF THE INVENTION

The present invention is generally related to computer networks. The present invention is also related to methods and systems for enabling the management of financial resources, investments, and business deals. Additionally, the present invention relates to web-based portals for tracking financial, investment and business deal information. In particular, the present invention relates to methods and systems for internally managing financial resources within a company, enterprise or organization.

### BACKGROUND OF THE INVENTION

The development of computerized information resources, such as the “Internet,” and the proliferation of “web” browsers, permit users of data-processing systems to link to other servers and networks, and thus retrieve vast amounts of electronic information heretofore unavailable in an electronic medium. Such electronic information generally is increasingly displacing more conventional means of information transmission, such as newspapers, magazines, and even television. As a result of this displacement, commercial enterprises and endeavors previously practiced only by conventional means of information transmission, are now being implemented and practiced via the Internet and so-called web browsers.

The term “Internet” is an abbreviation of “Internetwork,” and refers to the collection of networks and gateways that utilize the TCP/IP suite of protocols, which are well known in the art of computer networking. TCP/IP is an acronym for “Transport Control Protocol/Interface Program,” a software protocol originally developed by the Department of Defense for communication between computers, but now primarily utilized as one of a number of standardized Internet communications protocols.

In the last decade of the 20^{th} century, explosive growth occurred in the use of the globally-linked network of computers now known as the “Internet.” In particular, the World Wide Web, or simply the “web,” which facilitates the use of the Internet, has resulted in a revolution of electronic commerce and information transmission. The World Wide Web, well known in the Internet and computer networking arts, is generally composed of many pages or files of information distributed across a variety of computer servers and systems.

In order to utilize the World Wide Web, a client computer system runs a portion of software known as a graphical “Web” browser, such as Netscape

Navigator or Internet Explorer. “Netscape” and “Navigator” are trademarks of the Netscape Communications Corporation, while “Internet Explorer” is a trademark of Microsoft. The client computer system interacts with the browser to select a particular Universal Resource Locator (URL), by which each page is identified. The URL denotes both the server machine, and the particular file or page on that machine.

Many pages or URLs may reside on a single server. The selection of the URL in turn causes the browser to send a request for that URL or page to the server identified in the URL. Typically the server responds to the request by retrieving the requested page, and transmits the data for that page back to the requesting computer system. This page can be then displayed for the user to view on the client screen. The client may also cause the server to launch an application, for example, to search World Wide Web “pages” relating to particular topics.

Most World Wide Web pages are formatted in accordance with a computer program written in a language known as HTML (hypertext mark-up language). This program contains the data to be displayed via the client's graphical “web” browser, as well as formatting commands which “tell” the browser how to display the data. Thus, a typical “web” page includes text together with embedded formatting commands, referred to as “tags,” which can be utilized to control the font size, the font style (e.g., italic or bold), textual layout, and so forth. A web browser “parses” the HTML script in order to display the text in accordance with the specified format. HTML tags are also utilized to indicate how graphics, audio, and video are manifested to the user via the client's browser.

The majority of web pages also contain one or more references to other web pages, which need not be on the same server as the original page. Such references may generally be activated by the user selecting particular locations on the screen, typically by clicking a mouse control button. These references or locations are known as hyperlinks, and are typically flagged by the browser in a particular manner (e.g., any text associated with a hyperlink may appear graphically in a different color). If a user selects the hyperlink, then the referenced page can be retrieved, thereby replacing the currently displayed page.

Commercial enterprises, organizations, and companies are increasingly utilizing the World Wide Web to initiate commerce and management internal organizational resources. Several phases of electronic commerce via the World Wide Web, for example, have already taken place. The first phase, namely publicity for companies and organizations, has already occurred. Homepages are commonplace, an essential ingredient for any company which wishes to maintain itself in line with current business practices.

Publicity material posted electronically on company homepages typically it contains marketing information, product brands, and in some cases, product catalogues. Internal company homepages displayed within an “Intranet” also include product information, internal company organization information, and general internal announcements and correspondence. The “Intranet” is essentially a company internal version of the Internet.

The second phase, namely to conduct commerce, is generally emerging. Enterprises are poised to conduct business via the World Wide Web. They are seeking to make sales of their products and services, utilizing the World Wide Web. Software infrastructure is generally coming into existence to enable the progress of this trend. Secure financial protocols have been defined and are being implemented. The provision of firewall technologies offer safeguards to the enterprise, without which the enterprise would not contemplate permitting access to its critical data. Gateway products are becoming available to facilitate connection between the World Wide Web and server machines owned and operated by companies and commercial enterprises.

The third phase of commercial World Wide Web development, namely, the business-to-business arena, generally is only now being seriously implemented. Web business-to-business solutions require two components. First, a customer must be willing to engage in commercial transactions via the World Wide Web. Second, the company or enterprise anticipating customer participation must offer and implement a secure and efficient electronic information delivery system. Customers may either be external or internal to a company Intranet and may in fact be composed of internal company business units.

One problem that most companies and organizations face is the need to manage company financial resources and keep track of investments, information concerning past and future business deals, and research current financial and business information. Some attempts have been made to implement systems for tracking financial resources and company business data. Such systems, however, are typically inefficient, unreliable, and lack data integrity.

Tracking ongoing business deals also presents a problem to companies and organizations, because currently most business and investment professionals maintain papers relating to such deals in file folders, drawers and cabinets. Due to high attrition rates in current business organizations, new employees often inherit these papers without realizing the importance of the information they contain. Such papers are often simply thrown into boxes and stored in file rooms, thereby preventing a clean transfer of information from taking place. Thus, a need exists for a central repository of such information that can be readily and efficiently accessed without searching through boxes, file rooms, and so forth.

Based on the foregoing, those skilled in the art can appreciate that a need exists for a method and system to efficiently manage company financial portfolios and assets, along with information concerning past, present and potential business deals. It is believed that such a method and system can be implemented in an online environment, utilizing remote computer networks, such as the Internet or a company Intranet. It is believed that the method and system of the present invention, as disclosed and claimed herein, solves these problems.

### SUMMARY OF THE INVENTION

It is one aspect of the present invention to provide an interactive web-based portal for a remote computer network.

It is another aspect of the present invention to provide a method and system for enabling the management of financial resources, investments, and business deals.

It is yet another aspect of the present invention to provide a web-based portal for tracking financial, investment and business deal information.

It is still another aspect of the present invention to provide a method and system for electronically managing financial resources within a company, enterprise or organization.

The above and other aspects of the present invention are achieved as is now described. A method and system in a remote computer network for interactively managing financial information is disclosed herein, wherein the remote computer network has at least one client connectable to one or more servers. Initially, a deal center database can be designated wherein deal information may be maintained. An investment management database is then specified wherein investment management information can be stored. A financial management database is thereafter established, wherein financial management information can be maintained. Each of the databases are then integrated with one another in the remote computer network to permit users to access information stored in the databases.

A deal center interface is specified for interactively accessing deal center information stored in the deal center database, in addition to an investment management interface for interactively accessing investment management information stored in the investment management information database. Finally, a financial management interface is established for interactively accessing financial management information stored in the financial management information database. Each of the interfaces are integrated with one another in the remote computer network to thereby permit users to access information stored in the databases utilizing such interfaces.

### BRIEF DESCRIPTION OF DRAWINGS

FIG. 1 illustrates a pictorial representation of a computer system, which may be utilized to implement a preferred embodiment of the present invention;

FIG. 2 depicts a representative hardware environment of a computer system in which a preferred embodiment of the present invention can be implemented;

FIG. 3 illustrates a block diagram illustrative of a client/server architecture, in accordance with a preferred embodiment of the present invention;

FIG. 4 depicts a detailed block diagram of a client/server architecture in accordance with a preferred embodiment of the present invention;

FIG. 5 illustrates a block diagram of a computer network in which a preferred embodiment of the present invention can be implemented;

FIG. 6 depicts a high-level block diagram illustrative of a financial management system, in accordance with a preferred embodiment of the present invention;

FIG. 7 illustrates a work flow and data management diagram, in accordance with a preferred embodiment of the present invention;

FIG. 8 depicts a flow chart of operations illustrating operational steps for implementing a deal center interface, in accordance with a preferred embodiment of the present invention;

FIG. 9 illustrates a flow chart of operations illustrating operational steps for implementing an investment management interface, in accordance with a preferred embodiment of the present invention;

FIG. 10 depicts a flow chart of operations illustrating operational steps for implementing a financial management interface, in accordance with a preferred embodiment of the present invention;

FIG. 11 illustrates a flow chart of operations illustrating operational steps for implementing a web-based portal, in accordance with a preferred embodiment of the present invention;

FIG. 12 depicts a flow chart of operations illustrating operational steps for implementing an information delivery interface, in accordance with a preferred embodiment of the present invention;

FIG. 13 illustrates a high-level flow chart illustrating general investment and portfolio monitoring steps, in accordance with a preferred embodiment of the present invention; and

FIG. 14 depicts a flow chart of operations illustrating operational steps in a method for interactively managing financial information, in accordance with a preferred embodiment of the present invention.

### DESCRIPTION OF PREFERRED EMBODIMENTS

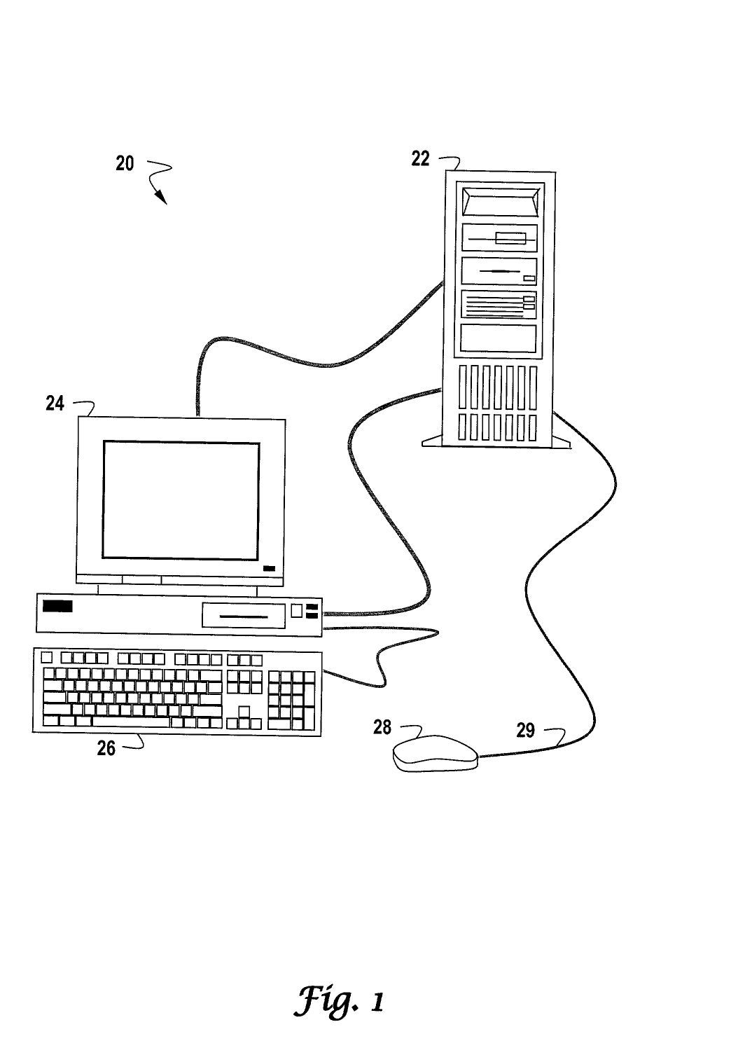

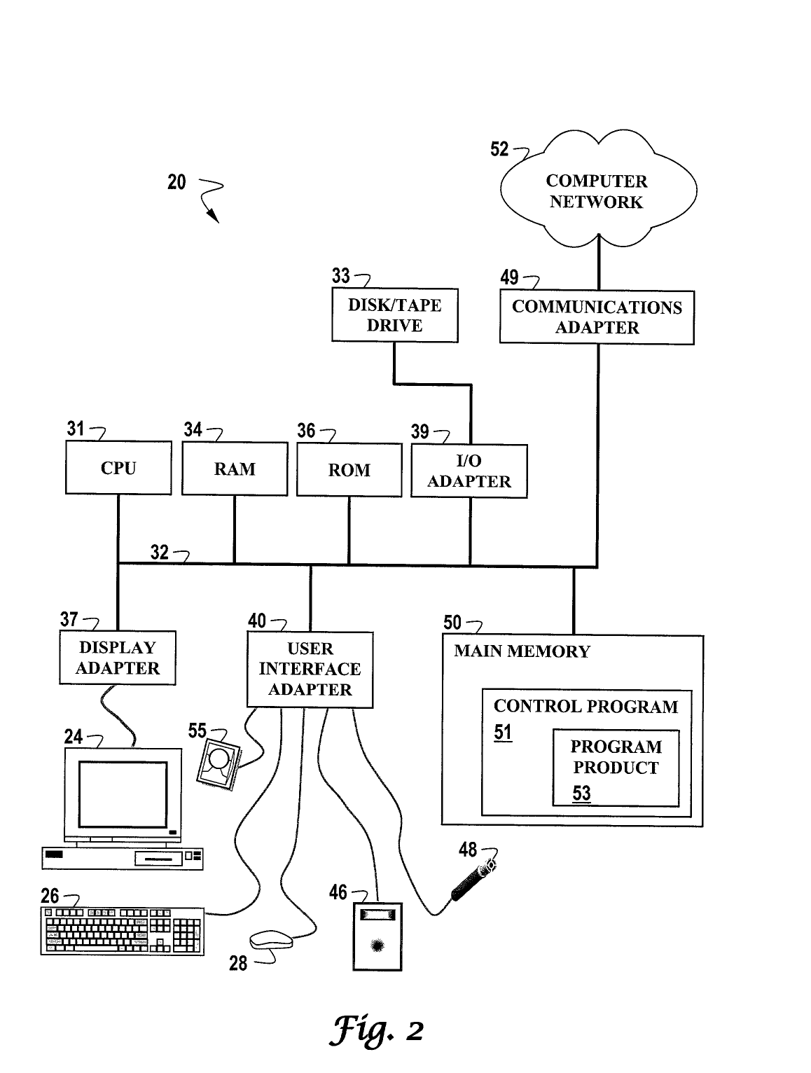

FIG. 1 illustrates a pictorial representation of a computer system 20, which may be utilized to implement a preferred embodiment of the present invention. Computer system 20 includes a system unit 22, a video display terminal 24, a keyboard 26, and a mouse 28. Those skilled in the art can appreciate that the method and system of the present invention apply equally to any computer system, regardless of whether the computer system is generally implemented as a complicated multi-user computing apparatus or a single-user workstation. In FIG. 1 and FIG. 2, like parts are identified by like numbers.

FIG. 2 depicts a representative hardware environment of the computer system of a preferred embodiment of the present invention. Computer system 20 includes a Central Processing Unit (“CPU”) 31, such as a conventional microprocessor, and a number of other units interconnected via system bus 32. Such components and units of computer system 20 can be implemented in a system unit such as system unit 22 of FIG. 1. Computer system 20 further includes random-access memory (“RAM”) 34, read-only memory (“ROM”) 36, display adapter 37 for connecting system bus 32 to video display terminal 24, and I/O adapter 39 for connecting peripheral devices (e.g., disk and tape drives 33) to system bus 32.

Video display terminal 24 generally provides the visual output of computer system 20. Video display terminal 24 can be implemented as a CRT-based video display, well known in the art of computer hardware. In the context of a portable or notebook-based computer, however, video display terminal 24 can be replaced with a gas plasma-based or LCD-based flat-panel display. Computer system 20 further includes user interface adapter 40 for connecting keyboard 26, mouse 28, speaker 46, microphone 48, and/or other user interface devices, such as a touch-screen device (not shown), to system bus 32. Communications adapter 49 connects computer system 20 to a computer network 52. Although computer system 20 is shown to contain only a single CPU and a single system bus, it should be understood that the present invention applies equally to computer systems that have multiple CPUs and to computer systems that have multiple buses that each perform different functions in different ways.

Computer system 20 also includes an interface that resides within a machine-readable media to direct the operation of computer system 20. Any suitable machine-readable media may retain the interface, such as RAM 34, ROM 36, a magnetic diskette, magnetic tape, or optical disk (the last three being located in disk and tape drives 33). Any suitable operating system and associated interface (e.g., Microsoft Windows) may direct CPU 31. Other technologies also can be utilized in conjunction with CPU 31, such as touch-screen technology or human voice control. Those skilled in the art can appreciate that the hardware depicted in FIG. 2 may vary for specific applications. For example, other peripheral devices such as optical disk media, audio adapters, or chip programming devices, such as PAL or EPROM programming devices well-known in the art of computer hardware and the like, may be utilized in addition to or in place of the hardware already depicted.

Main memory 50 is connected to system bus 32, and includes a control program 51. Control program 51 resides within main memory 50, and contains instructions that, when executed on CPU 31, carries out the operations depicted in the logic flow diagrams described herein. Control program 51 may be configured as a computer program product 53, which can also be referred to simply as a program product. Program product 53 may include routines or subroutines or software modules thereof.

It is important to note that, while the present invention has been (and will continue to be) described in the context of a fully functional computer system, those skilled in the art can appreciate that the present invention is capable of being distributed as a program product in a variety of forms, and that the present invention applies equally regardless of the particular type of signal-bearing media utilized to actually carry out the distribution. Examples of signal-bearing media include: recordable-type media, such as floppy disks, hard disk drives, and CD ROMs, and transmission-type media such as digital and analog communication links.

The program product itself may be compiled and processed as a module. In programming, a module is typically organized as a collection of routines and data structures that perform a particular task or implements a particular abstract data type. Modules are typically composed of two portions, an interface and an implementation. The interface lists the constants, data types, variables, and routines that can be accessed by other routines or modules. The implementation is private in that it is only accessible by the module. The implementation also contains source code that actually implements the routines in the module. Thus, a program product can be formed from a series of interconnected modules or instruction modules dedicated to working together to accomplish a particular task.

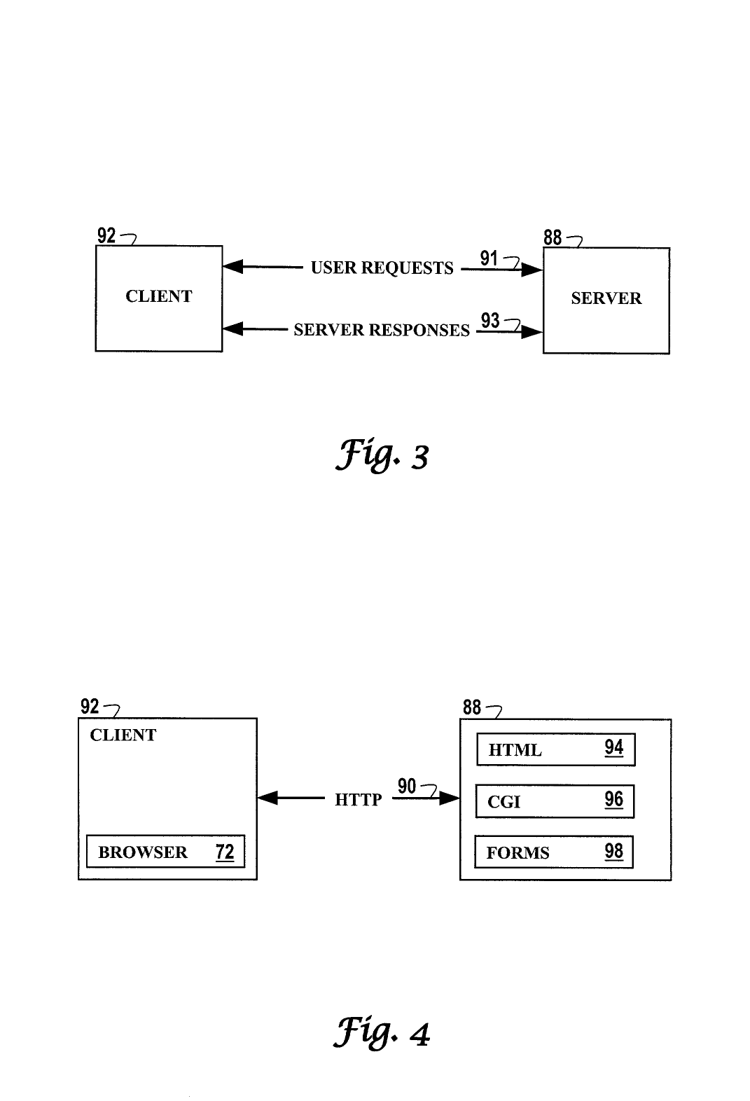

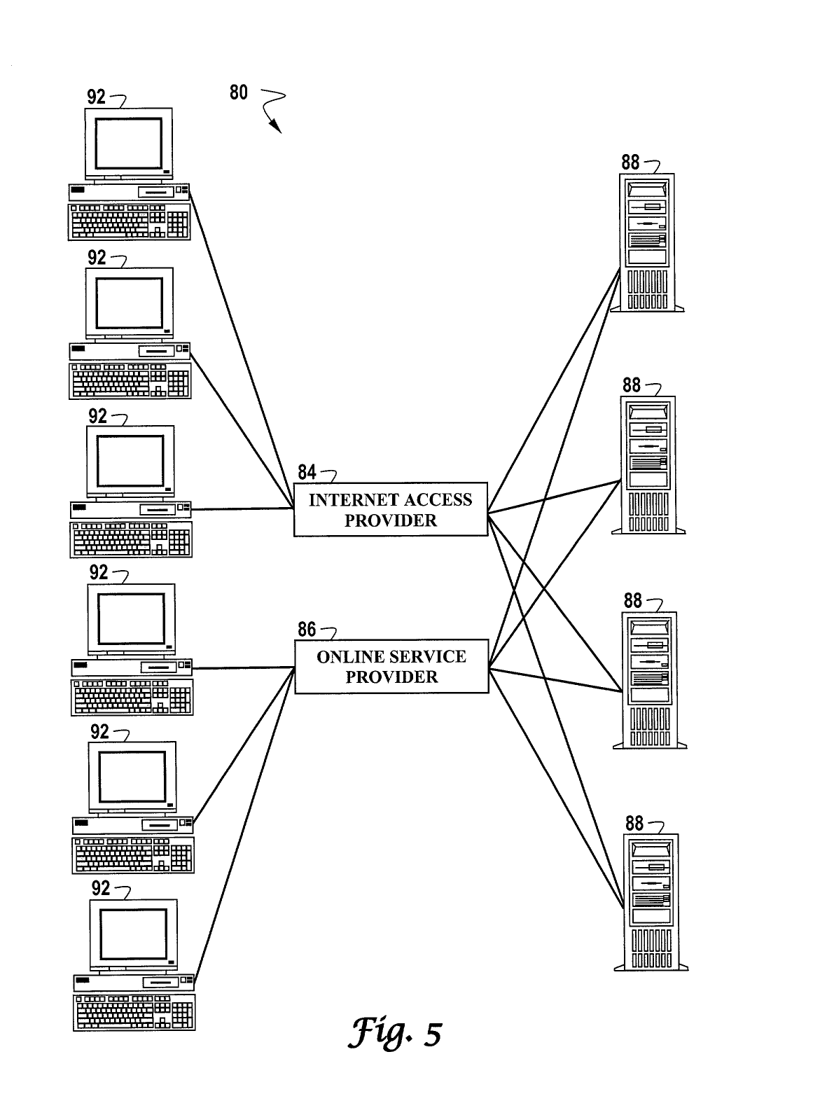

In FIG. 3, FIG. 4, and FIG. 5, like parts are indicated by like numbers. FIG. 3 illustrates a block diagram illustrative of a client/server architecture in accordance with a preferred embodiment of the present invention. In FIG. 3, user requests 91 for news are sent by a client application program 92 to a server 88. Server 88 can be a remote computer system accessible over the Internet or other communication networks. Client application program 92 may be utilized in association with computer 10 of FIG. 2 and the implementation of computer 10, as illustrated in FIG. 3.

Server 88 performs scanning and searching of raw (e.g., unprocessed) information sources (e.g., newswire feeds or newsgroups) and, based upon these user requests, presents the filtered electronic information as server responses 93 to the client process. The client process may be active in a first computer system, and the server process may be active in a second computer system, communicating with one another over a communications medium, thus providing distributed functionality and allowing multiple clients to take advantage of the information-gathering capabilities of the server.

FIG. 4 illustrates a detailed block diagram of a client/server architecture in accordance with a preferred embodiment of the present invention. Although the client and server are processes that are operative within two computer systems, these processes being generated from a high-level programming language (e.g., PERL), which is interpreted and executed in a computer system at runtime (e.g., a workstation), it can be appreciated by one skilled in the art that they may be implemented in a variety of hardware devices, either programmed or dedicated.

Client 92 and server 88 communicate utilizing the functionality provided by HTTP. Active within client 92 is a first process, browser 72, which establishes connections with server 88, and presents information to the user. Any number of commercially or publicly available browsers can be utilized in various implementations in accordance with the preferred embodiment of the present invention. Browsers, such as Netscape™, also provide the functionality specified under HTTP. “Netscape” is a trademark of Netscape, Inc.

Server 88 executes the corresponding server software, which presents information to the client in the form of HTTP responses 90. The HTTP responses 90 correspond with the web pages represented using HTML, or other data generated by server 88. Server 88 provides HTML 94. With certain browsers, a Common Gateway Interface (CGI) 96 is also provided, which allows the client program to direct server 88 to commence execution of a specified program contained within server 88. This may include a search engine that scans received information in the server for presentation to the user controlling the client.

By utilizing this interface, and HTTP responses 90, server 88 may notify the client of the results of that execution upon completion. Common Gateway Interface (CGI) 96 is one form of a gateway, a device utilized to connect dissimilar networks (i.e., networks utilizing different communications protocols) so that electronic information can be passed from one network to the other. Gateways transfer electronic information, converting such information to a form compatible with the protocols used by the second network for transport and delivery.

In order to control the parameters of the execution of this server-resident process, the client may direct the filling out of certain “forms” from the browser. This is provided by the “fill-in-forms” functionality (i.e., forms 98), that is provided by some browsers, such as the Netscape-brand browser described herein. This functionality allows the user via a client application program to specify terms in which the server causes an application program to function (e.g., terms or keywords contained in the types of stories/articles, which are of interest to the user). This functionality is an integral part of the search engine.

FIG. 5 is a diagram illustrative of a computer network 80, which can be implemented in accordance with a preferred embodiment of the present invention. Computer network 80 is representative of the Internet, which can be described as a known computer network based on the client-server model discussed herein. Conceptually, the Internet includes a large network of servers 88 that are accessible by clients 92, typically users of personal computers, through some private Internet access provider 84 (e.g., such as Internet America) or an on-line service provider 86 (e.g., such as America On-Line, Prodigy, Juno, and the like). Each of the clients 92 may run a browser to access servers 88 via the access providers. Each server 88 operates a so-called “web” site or portal that supports files in the form of documents and web pages. A network path to servers 88 is identified by a Universal Resource Locator (URL) having a known syntax for defining a network collection. Computer network 80 can thus be considered a web-based computer network. Computer network 80 is analogous to computer network 52 of FIG. 2.

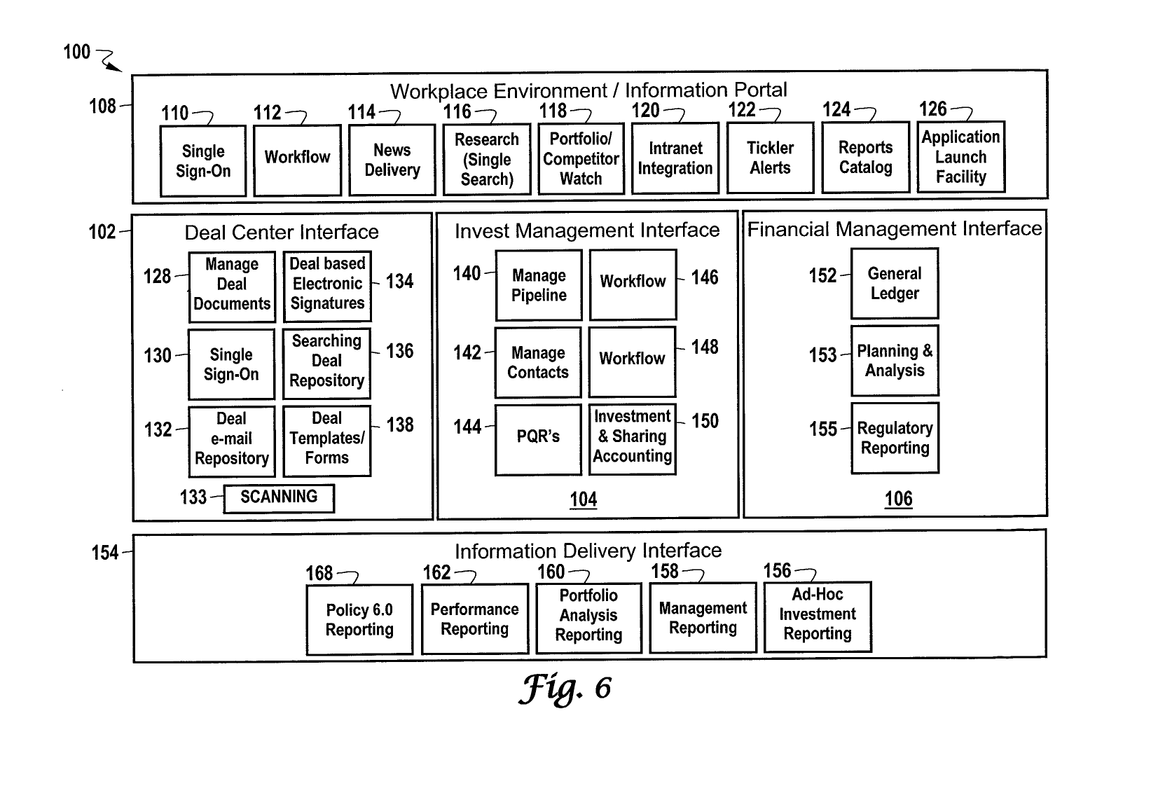

FIG. 6 depicts a high-level block diagram 100 illustrative of a financial management system, in accordance with a preferred embodiment of the present invention. The financial management system illustrated in block diagram 100 is composed of a deal center interface 102, an investment management interface 104, a financial management interface 106, an information portal 108, and an information delivery interface 154.

Deal center interface 102 is composed of a number of modules that permits users to update and access information concerning business deals. For example, deal center interface 102 is composed of a module 128 that permits users to manage documents related to such deals. Such documents may include items, such as non-disclosure agreements, term sheets, financial models, due-diligence information, working papers, closing certificates, and so forth. Hard copies of such documents can be scanned and stored within a database associated with deal center interface 102. Such a database is generally referred to herein as a deal center database. Those skilled in the art will appreciate that a scanner is simply an optical input device that utilizes light-sensitive equipment to capture an image on paper. The image is translated into a digital signal that may be manipulated by optical character recognition (OCR) software or graphics software. A scanner is represented in FIG. 6 as block 133.

Deal center interface 102 additionally includes a module 130 that provides users with a “deal checklist,” whereby various pre-defined steps can be followed to track and complete a business deal. Module 132 permits a user to store and retrieve e-mails associated with particular business deals. Such e-mail messages can be stored in a portion of the deal center database that functions as an e-mail repository, or simply in a separate e-mail repository that can be accessed by a user from deal center interface 102.

Deal templates and forms may also be provided to users, as indicated at module 138. Such templates may be modified by the user to reflect current deals. For example, if a user requires a nondisclosure agreement template, or other legal templates, such forms may be accessed from the deal center interface 102, and thereafter, modified to suit the needs of the deal in question. Those skilled in the art can thus appreciate that a wide-variety of templates and forms may be provided to a user through module 138.

A search mechanism is also provided, as indicated at module 136, wherein a user may search and retrieve particular information stored in the deal center database (i.e., also referred to as a “deal repository”). Finally, module 134 users to sign documents with electronic signatures, and route the documents to other users for additional electronic signatures, rather than the necessity of utilizing hardcopy documents. When all electronic signatures are collected for a particular document, the document is then stored in the deal center database, along with the associated electronic signatures, for later retrieval.

Investment management interface 104 includes a module 140 that permits users to manage past, current and pending business deals in the deal “pipeline.” Users accessing module 140 can compile information related to past, pending and potential business deals. Module 142 permits users to manage deal contacts (e.g., names, address, e-mails and so forth of deal participants). Module 144 permits users to access information describing portfolio quality. Referred to herein as a Portfolio Quality Report (PQR), module 144 allows users to review company investments and related information indicating how well such investments are performing.

All PQR's and related data can be stored in an investment management database associated with investment management interface 104. Module 146 permits users to manage deal organization structures, while module 148 permits users to service their investment portfolio. Module 150 can be implemented as an accounting module wherein investment and sharing information related to particular deals between companies may be stored and tracked accordingly.

Financial management interface 106 provides a module 152 for implementing a general ledger focusing on financial accounting, data conversion, data integrity, and rapid cycle times. This general ledger is linked to a module 153, which permits users to implement financial planning and analysis routines related to business deals and/or portfolio investments. Finally, financial management interface 106 includes a module 155 that permits users to access and generate reports related to financial regulatory requirements (e.g., Securities & Exchange Commission).

The information delivery interface 154 includes a module 158 that a user may utilize to access policy information and a module 162 for generating performance reports. Module 160 can be utilized for performing a portfolio analysis. Finally, information delivery interface 154 includes a module 156 for ad-hoc investment reporting. Information delivery interface 154 permits a user to generate information that generally must be reported to business managers in order to successfully manage their company's finances and investment portfolio. Information delivery interface 154 is linked with investment management interface 104 and financial management interface 106, thereby permitting information maintained in the investment management database and the financial management database to be utilize to generate performance reports, portfolio analysis reports, management reports, ad-hoc investment reports, and so forth.

Information portal 108 can be implemented as a web-based portal that users may access to perform a variety of financial and investment management functions. Module 110 enables users to sign on once to access a variety of financial, business, information, and application modules, including search mechanism modules. Module 112 manages a user's workflow, thereby permitting documents and data to be transferred and utilized by the deal center interface, investment management interface, financial management interface, and information delivery interface. Module 114 implements a news delivery capability. When a user accesses his or her own account via a single user sign on module, the user can receive the latest business and financial updates. Such news updates are generally displayed within a particular display area of information portal 108.

Additionally, information portal 108 includes a research module 116 composed of a single search engine that permits users to search multiple information and news services simultaneously rather than having to search each information and news service consecutively. For example, a user utilizing research module 116 can search the Dow Jones, NASDAQ, Bloomberg and other information and news services simultaneously rather than having to search each service separately. Those skilled in the art can appreciate that the term “search engine” as utilized herein refers to a program that searches for key words in documents or in database. Most search engines are configured as programs that search for keywords in files and documents found on the World Wide Web, newsgroups, gopher menus, and FTP archives. The term “search engine” is well known in the computer networking arts.

Module 118 permits a user to compile and maintain information related to particular user-designated business and financial competitors. Module 120 permits information portal 108 to be integrated with a company Intranet, while module 122 provides “tickler alerts” to the user via the user's personal account. Module 124 can be utilized by a user to compile a catalog of previously generated reports (i.e., regulatory reports, performance reports, and so forth), while module 126 permits a user to launch particular applications, such as the deal center interface, investment management interface, financial management interface, and information delivery interface.

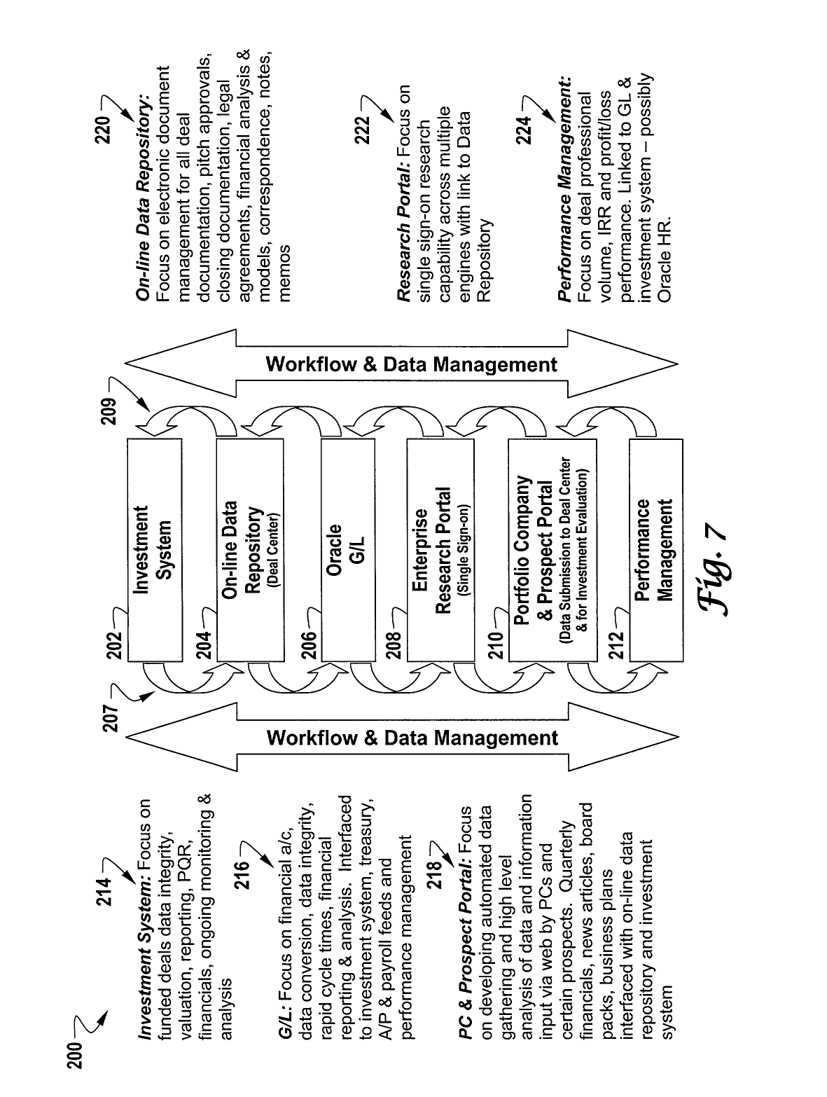

FIG. 7 illustrates a work flow and data management diagram 200, in accordance with a preferred embodiment of the present invention. Diagram 200 is a high-level diagram representing various functional aspects of the method and system described herein, including an investment system 200 linked to an on-line data depository 204, which in turn is linked to a general ledger 206. General ledger 206 is linked to a research portal 208, which in turn is linked to a portfolio company and prospect portal 210. Finally, the portfolio company and prospect portfolio is linked to a performance management module 212. Workflow and data management flows in either direction as indicated by curved arrow sets 207 and 209 in FIG. 7.

Investment system 202 focuses on funded business deals, data integrity, valuation, reporting, PQR, financials, and ongoing monitoring and analysis, as illustrated at definition 214. Online data repository 220 focuses on electronic document management for all deal related documents, information concerning deal approval pitches, closing documents, legal agreements, financial analysis and models, correspondence, notes, and memos, as depicted at definition 214. Online data repository 220 may be functionally implemented by deal center interface 102, as illustrated in FIG. 6.

General ledger 216 focuses on financial accounts, data conversion, data integrity, rapid cycle times, financial reporting and analysis, and is interfaced with investment system 202, and system, treasury, payroll and performance management. General ledger 206 may be implemented as module 152 of FIG. 6. General ledger 206 is explained generally at definition 216. Enterprise research portal 208 focuses on a single sign-on research capability across multiple search engines with a link to a data repository. Research portal 222 may be functionally implemented by module 110 and module 116 of FIG. 6, which together form an “enterprise research portal,” a sub-section of information portal 108 of FIG. 6. Enterprise research portal 222 is further explained at definition 222.

Portfolio company and prospect portal 210, which is generally described at definition 218, focuses on automated data gathering and high-level data analysis input by users through information portal 108 of FIG. 6. Such users may represent portfolio companies and prospects. The information may be manually input by users or automatically generated and transferred from the portfolio companies and prospects utilizing World Wide Web or Internet/Intranet functions. Portfolio company and prospect portal 210 permits users to access and retrieve quarterly financial information, news articles, and business plans interfaced with an online data repository 204 and investment system 202. Performance management module 224, as indicated at definition 224, focuses on deal professional volume, profit/loss performance, is linked to general ledger 206 and investment system 202, or other databases and interface environments as needed.

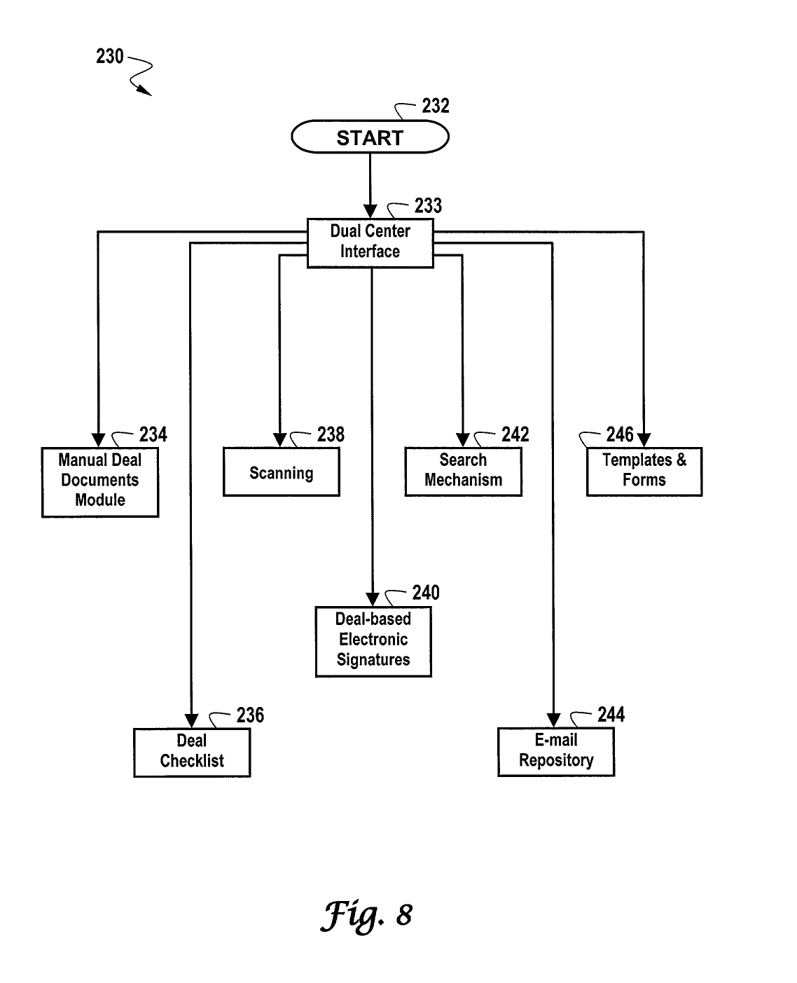

FIG. 8 depicts a flow chart of operations 230 illustrating operational steps for implementing a deal center interface, in accordance with a preferred embodiment of the present invention. As indicated at block 232, the process is initiated. Thereafter, as indicated at block 233, a user accessing the deal center interface, is faced with a variety of deal management choices, including a module for managing deal related documents, as illustrated at block 234, and a module for implementing a deal checklist which a user can utilize to keep track of a particular deal's progression, as depicted at block 236.

Additionally, a user may access a module that permits deal-based electronic signatures to be associated with electronic documents, as described at block 240. A user may also access a search mechanism, as illustrated at block 242, composed of a dedicated search engine for searching and retrieving deal related documents and templates maintained in the deal center database.

The user may also access an e-mail repository, as depicted at block 244, which contains e-mail messages linked to particular deals. Such an e-mail repository can be implemented as a sub-section of the deal center database or as a separate e-mail repository database, depending on the needs of the user's and the requirements of the system. Finally, a user may also access, as illustrated at block 246, various templates and forms for completing and implementing a particular business deal. Such templates and forms may include articles of incorporation templates, nondisclosure agreements, and so forth.

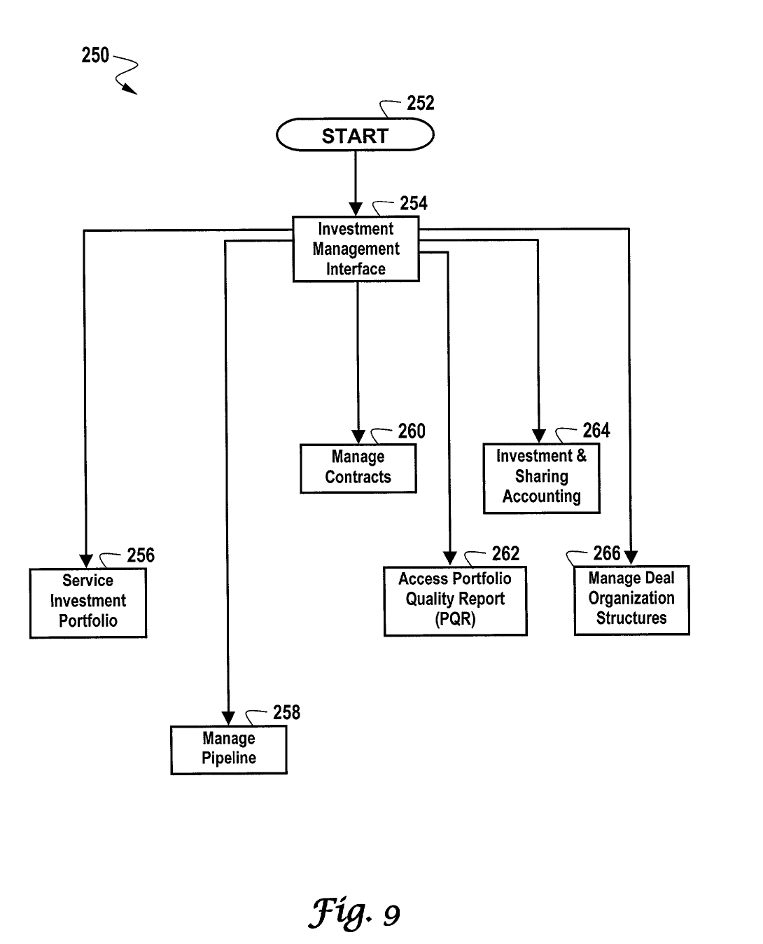

FIG. 9 illustrates a flow chart of operations 250 illustrating operational steps for implementing an investment management interface, in accordance with a preferred embodiment of the present invention. As indicated at block 252, the process is initiated. As illustrated thereafter at block 254, a user may directly or indirectly access the investment management interface. A variety of functional investment management tools may be utilized through the investment management interface, including a service investment portfolio module, as described at block 256 and a management pipeline module, as illustrated at block 258. A module for managing business and portfolio contacts may also be accessed and utilized, as illustrated at block 260, through the investment interface. Portfolio quality reports (PQR's) may also be accessed through the investment management interface, as depicted at block 262. A module for investment sharing and accounting may also be accessed through the investment management interface, as indicated at block 264. Finally, a module for managing deal organization structures may be accessed, as illustrated at block 266.

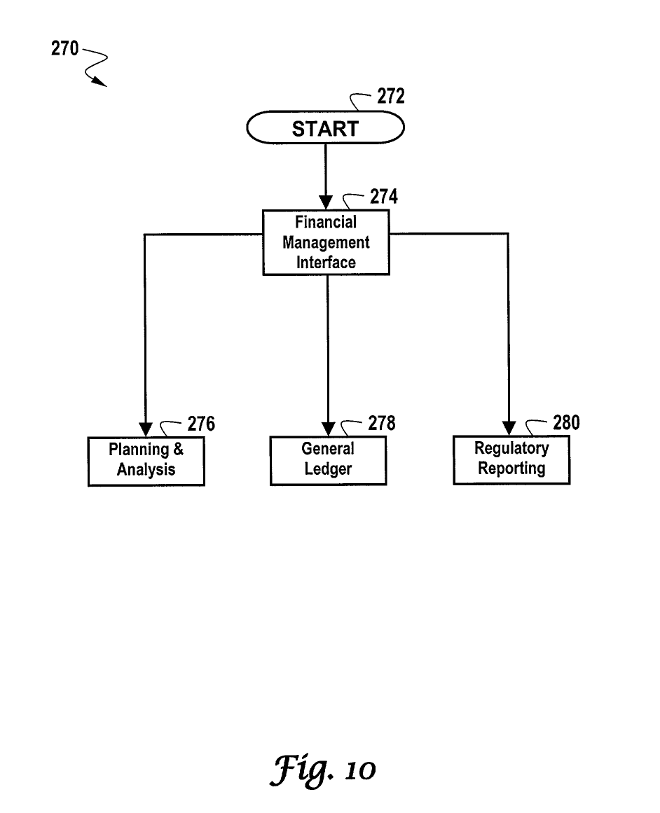

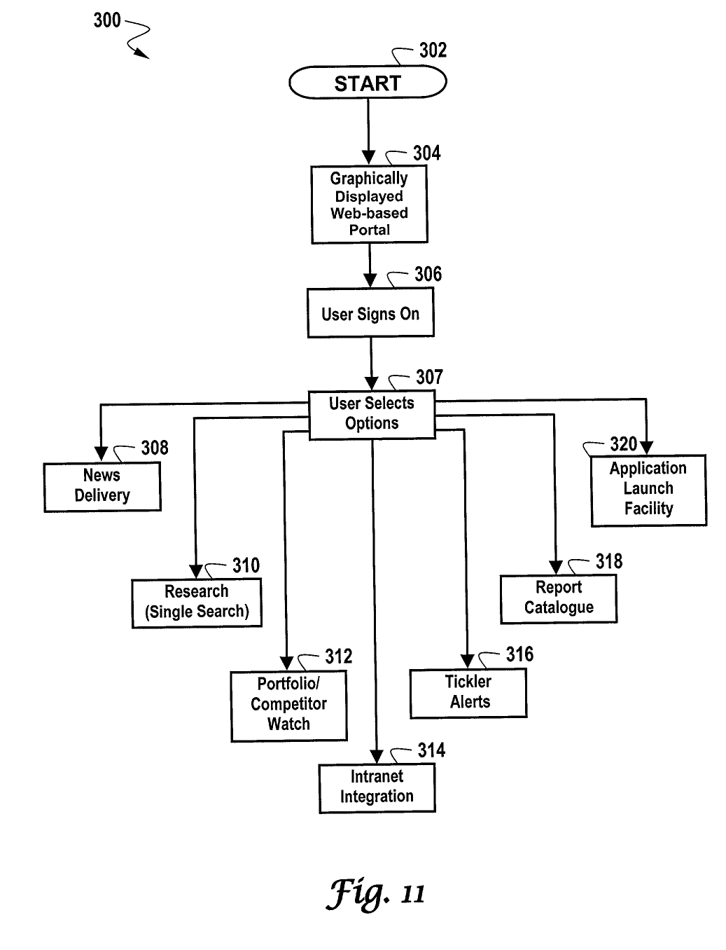

FIG. 10 depicts a flow chart of operations 270 illustrating operational steps for implementing a financial management interface, in accordance with a preferred embodiment of the present invention. As indicated at block 272, the process is initiated. As described thereafter at block 274, a financial management interface is accessed wherein a user can utilize a module for financial planning and analysis, as illustrated at block 276. The user may also access a general ledger, as indicated at block 278. In addition, the user may access regulatory reporting module, as indicated at block 280.

FIG. 11 illustrates a flow chart of operations 300 illustrating operational steps for implementing a web-based portal, in accordance with a preferred embodiment of the present invention. The process is initiated, as depicted at block 302, and thereafter, as indicated at block 304, the web-based portal (information portal) is graphically displayed within a display area of a web browser. A user accesses the web-based portal through a particular sign-on or log on procedure, as illustrated at block 306. The user then may a select particular functional applications, as illustrated at block 307, from the web-based portal. The user can access a news delivery module, as illustrated at block 308, or a research module (i.e., search engine) as indicated at block 310. Such a research module permits a user to focus on research across multiple search engines with links to an online database, such as the deal center database described herein.

The user may also access, through the web-based portal, a module for analyzing and compiling information related to competitor's portfolios, as illustrated at block 312. A module for integrating the web-based portal with a particular company Intranet may also be accessed and manipulated, as described at block 314. A module that provides informational financial “tickler” alerts can also be accessed through the web-based portal, as illustrated at block 316. In addition, the user may compile and access a report catalogue, as described at block 318, containing an index of various previously generated reports. Such reports may have been generated by that particular user or other users. Finally, as depicted at block 320, various applications may be launched via an application launch facility module.

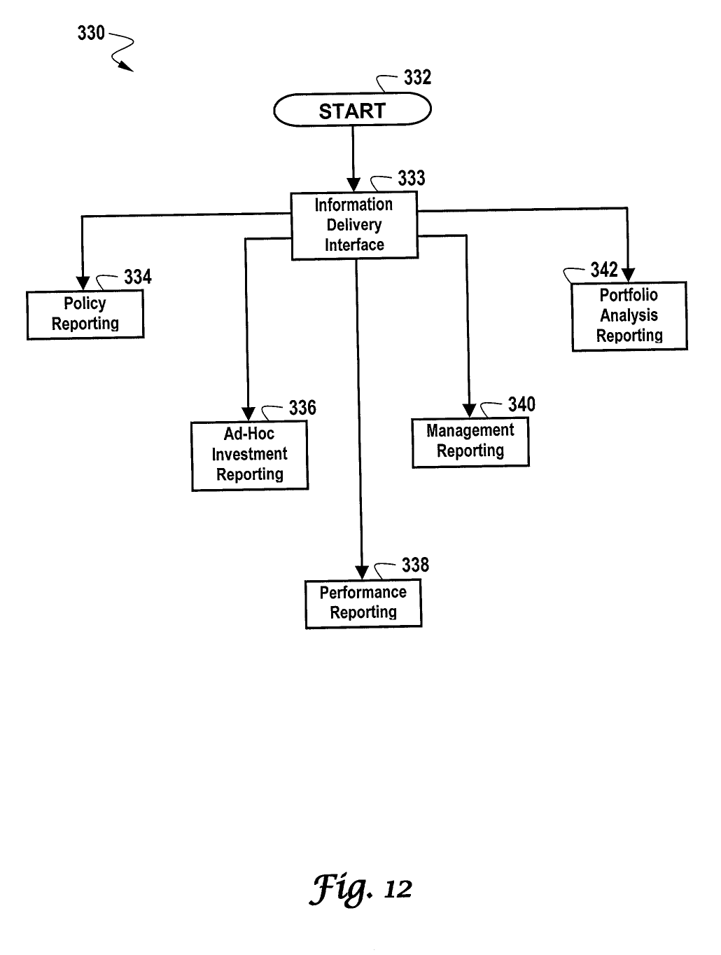

FIG. 12 depicts a flow chart of operations 330 illustrating operational steps for implementing an information delivery interface, in accordance with a preferred embodiment of the present invention. As indicated at block 332, the process is initiated. As illustrated thereafter at block 333, a user may access an information delivery interface, either directly or indirectly, in order to perform a variety of information delivery functions. Such functions include policy reporting, as illustrated at block 334, and ad-hoc investment reporting, as described at block 336. Additionally, a user may compile and generate performance reports, as depicted at block 338, or management reports, as illustrated at block 340. Finally, a user may compile portfolio analysis reports, as indicated at block 340.

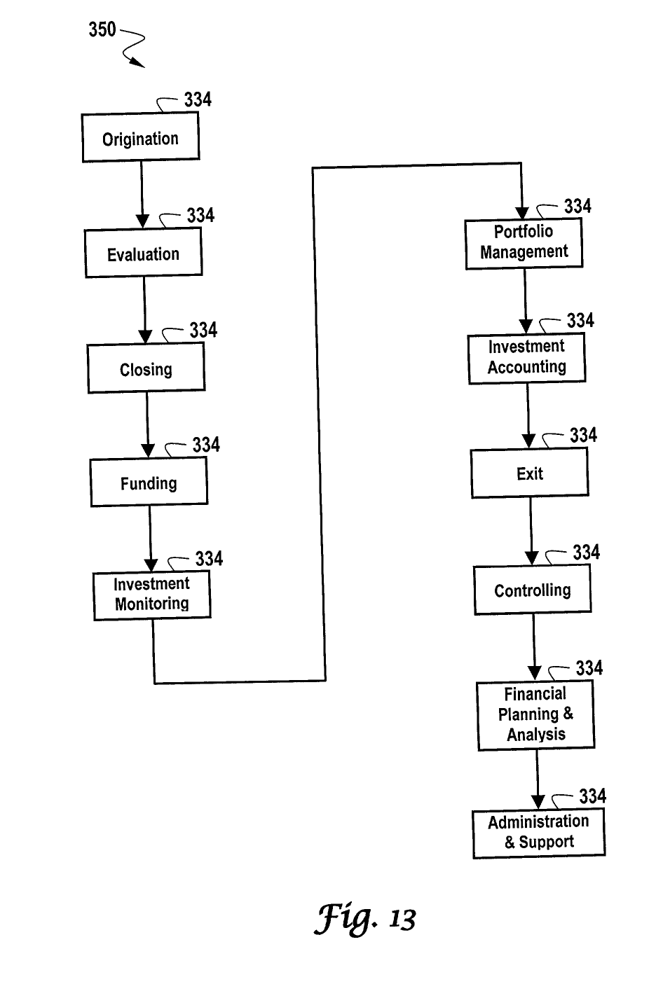

FIG. 13 illustrates a high-level flow chart 350 illustrating general investment and portfolio monitoring steps, in accordance with a preferred embodiment of the present invention. As illustrated at block 352, a business deal is originated. Thereafter, the deal is evaluated, as depicted at block 354. Following evaluation of the deal, closing takes place, as illustrated at block 356. The deal is then funded, as described at block 358. Thereafter, investment monitoring occurs, as illustrated at block 360. Investment monitoring can be implemented utilizing the web-based portal described earlier, along with its associated modules and interfaces. Portfolio monitoring occurs, as indicated at block 362, again, utilizing the web-base portal. Investment accounting is implemented thereafter, as indicated at block 364, and thereafter investment and portfolio and monitoring, along with investment accounting, is terminated, as indicated at block 366. Given the results of investment and portfolio monitoring and investment accounting, appropriate data can be controlled, as illustrated at block 368, and analyzed for financial planning purposes, as described at block 370. Finally, a given business deal is administered with appropriate company support, as illustrated at block 372.

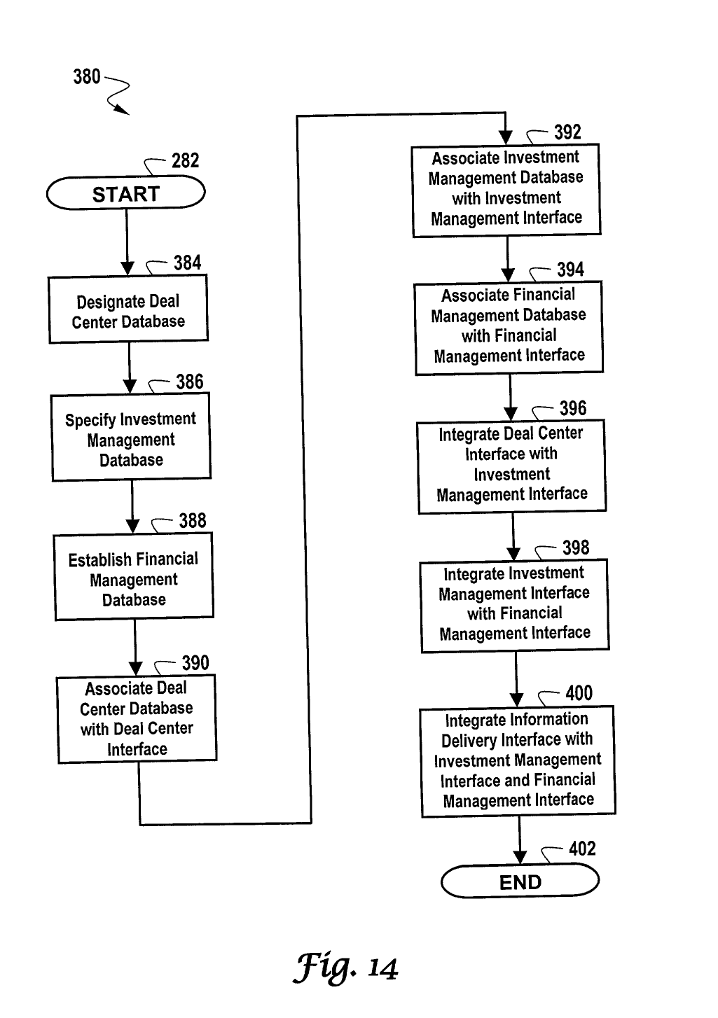

FIG. 14 depicts a flow chart of operations 380 illustrating operational steps in a method for interactively managing financial information, in accordance with a preferred embodiment of the present invention. Such a method may be implemented in a remote computer network having at least one client computer linked to one or more servers. The process is initiated, as illustrated at block 382, and thereafter as depicted at block 384, a deal center database is designated, wherein deal information may be stored.

As described next at block 386, an investment management database is specified wherein investment management information can be stored. A financial management database is established, as indicated at block 388, wherein financial management information can be stored. As depicted thereafter at block 390, the deal center database is linked to or associated with a deal center interface, such as the deal center interface described in FIG. 6 herein. Likewise, the investment management database, as described at block 392, is associated with an investment management interface, such as the investment management interface depicted in FIG. 6 herein. A financial management interface, such as the financial management interface illustrated in FIG. 6 and described herein, is linked to or associated with the financial management database, as illustrated at block 394. As illustrated at block 396, the deal center interface is integrated with the investment management interface, such that information may be transferred from one interface to the other for particular compilation and processing.

Next, as indicated at block 398, the investment management interface is integrated with a financial management interface, such as the financial management interface depicted in FIG. 6 and described in greater detail herein. As indicated next at block 400, an information delivery interface is integrated with the investment management interface and the financial management interface, thereby permitting users to access, transfer and manipulate information from the various designated and specified database to generate reports and interactively keep track of related deal documents and material. Finally, the process terminates, as illustrated at block 402.

The embodiments and examples set forth herein are presented in order to best explain the present invention and its practical applications and to thereby enable those skilled in the art to make and utilize the invention. Those skilled in the art can recognize that the foregoing description and examples have been presented for the purposes of illustration and example only. The description as set forth herein is not intended to be exhaustive or to limit the invention to the precise form disclosed. For example, those skilled in the art can appreciate that the present invention can be utilized not only in the financial industries and arts, but in a wide variety of other industries. Many modifications and variations are possible in light of the above teaching without departing from the spirit and scope of the following claims.

1. A method in a remote computer network for interactively managing financial information, wherein said remote computer network has at least one client connectable to one or more servers, said method comprising the steps of:
designating a deal center database wherein deal information is stored;
specifying an investment management database wherein investment management information is stored;
establishing a financial management database wherein financial management information is stored; and
integrating each of said databases with one another in said remote computer network to thereby permit users to access information stored in said databases utilizing said remote computer network.

2. The method of claim 1 further comprising the steps of:
designating a deal center interface for interactively accessing deal center information stored in said deal center database;
specifying an investment management interface for interactively accessing investment management information stored in said investment management information database;
establishing a financial management interface for interactively accessing financial management information stored in said financial management information database; and
integrating each of said interfaces with one another in said remote computer network to thereby permit users to access information stored in said databases through said interfaces.

3. The method of claim 2 further comprising the steps of:
associating said deal center database with said deal center interface;
associating said investment management database with said investment management interface; and
associating said financial management database with said financial management interface.

4. The method of claim 3 wherein the step of designating a deal center database wherein deal information is stored, further comprises the step of:
designating a deal center database wherein deal information is stored, including electronic mail, due-diligence checklists, and deal information templates.

5. The method of claim 4 wherein the step of designating a deal center interface for interactively accessing deal center information stored in said deal center database, further comprises the step of:
designating a tracking mechanism for interactively tracking electronic mail stored in said deal center database; and
permitting a user to retrieve particular electronic mail stored in said deal center database, in response to tracking said particular electronic mail utilizing said tracking mechanism.

6. The method of claim 5 wherein the step of integrating each of said interfaces with one another in said remote computer network to thereby permit users to access information stored in said databases through said interfaces, further comprises the step of:
integrating said deal center interface with said investment management interface.

7. The method of claim 6 wherein the step of integrating each of said interfaces with one another in said remote computer network to thereby permit users to access information stored in said databases through said interfaces, further comprises the step of:
integrating said investment management interface with said financial management interface.

8. The method of claim 7 wherein the step of integrating each of said interfaces with one another in said remote computer network to thereby permit users to access information stored in said databases through said interfaces, further comprises the step of:
integrating an information delivery interface with said investment management interface; and
integrating said information delivery interface with said financial management interface.

9. The method of claim 8 further comprising the step of:
configuring said information delivery interface to permit users to generate particular reports based on data transferred from said investment management interface to said information delivery interface.

10. The method of claim 9 further comprising the step of:
configuring said information delivery interface to permit users to generate policy information.

11. A system in a remote computer network for interactively managing financial information, wherein said remote computer network has at least one client connectable to one or more servers, said system comprising:
module for designating a deal center database wherein deal information is stored;
module for specifying an investment management database wherein investment management information is stored;
module for establishing a financial management database wherein financial management information is stored; and
module for integrating each of said databases with one another in said remote computer network to thereby permit users to access information stored in said databases utilizing said remote computer network.

12. The system of claim 11 further comprising:
module for designating a deal center interface for interactively accessing deal center information stored in said deal center database;
module for specifying an investment management interface for interactively accessing investment management information stored in said investment management information database;
module for establishing a financial management interface for interactively accessing financial management information stored in said financial management information database; and
module for integrating each of said interfaces with one another in said remote computer network to thereby permit users to access information stored in said databases through said interfaces.

13. The system of claim 2 further comprising:
module for associating said deal center database with said deal center interface;
module for associating said investment management database with said investment management interface; and
module for associating said financial management database with said financial management interface.

14. The system of claim 13 wherein said module for designating a deal center database wherein deal information is stored, further comprises:
module for designating a deal center database wherein deal information is stored, including electronic mail, due-diligence checklists, and deal information templates.

15. The system of claim 14 wherein said module for designating a deal center interface for interactively accessing deal center information stored in said deal center database, further comprises:
module for designating a tracking mechanism for interactively tracking electronic mail stored in said deal center database; and
module for permitting a user to retrieve particular electronic mail stored in said deal center database, in response to tracking said particular electronic mail utilizing said tracking mechanism.

16. The system of claim 15 wherein said module for integrating each of said interfaces with one another in said remote computer network to thereby permit users to access information stored in said databases through said interfaces, further comprises:
module for integrating said deal center interface with said investment management interface.

17. The system of claim 16 wherein said module for integrating each of said interfaces with one another in said remote computer network to thereby permit users to access information stored in said databases through said interfaces, further comprises:
module for integrating said investment management interface with said financial management interface.

18. The system of claim 17 wherein said module for integrating each of said interfaces with one another in said remote computer network to thereby permit users to access information stored in said databases through said interfaces, further comprises:
module for integrating an information delivery interface with said investment management interface; and
module for integrating said information delivery interface with said financial management interface.

19. The system of claim 18 further comprising:
module for configuring said information delivery interface to permit users to generate particular reports based on data transferred from said investment management interface to said information delivery interface.

20. The system of claim 19 further comprising:
module for configuring said information delivery interface to permit users to generate policy information.

21. A program product residing in computer memory in a remote computer network for interactively managing financial information, wherein said remote computer network has at least one client connectable to one or more servers, said program product comprising:
instruction module for designating a deal center database wherein deal information is stored;
instruction module for specifying an investment management database wherein investment management information is stored;
instruction module for establishing a financial management database wherein financial management information is stored; and
instruction module for integrating each of said databases with one another in said remote computer network to thereby permit users to access information stored in said databases utilizing said remote computer network.

22. The program product of claim 21 further comprising:
instruction module for designating a deal center interface for interactively accessing deal center information stored in said deal center database;
instruction module for specifying an investment management interface for interactively accessing investment management information stored in said investment management information database;
instruction module for establishing a financial management interface for interactively accessing financial management information stored in said financial management information database; and
instruction module for integrating each of said interfaces with one another in said remote computer network to thereby permit users to access information stored in said databases through said interfaces.

23. The program product of claim 22 further comprising:
instruction module for associating said deal center database with said deal center interface;
instruction module for associating said investment management database with said investment management interface; and
instruction module for associating said financial management database with said financial management interface.

24. The program product of claim 23 wherein said instruction module for designating a deal center database wherein deal information is stored, further comprises:
instruction module for designating a deal center database wherein deal information is stored, including electronic mail, due-diligence checklists, and deal information templates.

25. The program product of claim 24 wherein said instruction module for designating a deal center interface for interactively accessing deal center information stored in said deal center database, further comprises:
instruction module for designating a tracking mechanism for interactively tracking electronic mail stored in said deal center database; and
instruction module for permitting a user to retrieve particular electronic mail stored in said deal center database, in response to tracking said particular electronic mail utilizing said tracking mechanism.

26. The program product of claim 25 wherein said instruction module for integrating each of said interfaces with one another in said remote computer network to thereby permit users to access information stored in said databases through said interfaces, further comprises:
instruction module for integrating said deal center interface with said investment management interface.

27. The program product of claim 26 wherein said instruction module for integrating each of said interfaces with one another in said remote computer network to thereby permit users to access information stored in said databases through said interfaces, further comprises:
instruction module for integrating said investment management interface with said financial management interface.

28. The program product of claim 27 wherein said instruction module for integrating each of said interfaces with one another in said remote computer network to thereby permit users to access information stored in said databases through said interfaces, further comprises:
instruction module for integrating an information delivery interface with said investment management interface; and
instruction module for integrating said information delivery interface with said financial management interface.

29. The program product of claim 28 further comprising:
instruction module for configuring said information delivery interface to permit users to generate particular reports based on data transferred from said investment management interface to said information delivery interface.

30. The program product of claim 29 further comprising:
instruction module for configuring said information delivery interface to permit users to generate policy information.

31. The program product of claim 30 wherein each of said instruction modules further comprise signal-bearing media.

32. The program product of claim 31 wherein said signal-bearing media comprises transmission media.

33. The program product of claim 31 wherein said signal-bearing media comprises recordable media.
